(19) United States
(12) Patent Application Publication
(10) Pub. No.: US 2014/0160367 A1
(43) Pub. Date: Jun. 12, 2014

(54) DISPLAY SCREEN ASSEMBLY

(71) Applicant: Chiun Mai Communication Systems, Inc., New Taipei (TW)

(72) Inventors: Chun-Ta HUANG, New Taipei (TW); Kuan-Chung SHIH, New Taipei (TW)

(73) Assignee: Chiun Mai Communication Systems, Inc., New Taipei (TW)

(21) Appl. No.: 14/057,135

(22) Filed: Oct. 18, 2013

(30) Foreign Application Priority Data
Dec. 6, 2012 (TW) 101145782

(51) Int. Cl. G06F 1/16

(52) U.S. Cl. CPC G06F 1/1626
USPC 349/12

(57) ABSTRACT

A display screen assembly includes a shell, a display screen, and a touch screen. The shell has two opposite side walls and forms an accommodating space. Each side wall has a protruding portion which slants up and out and which extends into the accommodating space. Each protruding portion has a supporting surface. The display screen is received in the accommodating space. The touch screen is convex and made to cover the protruding portions all the way to their respective outer edges. The touch screen is secured in the accommodating space and the upwardly-sloping and reflective surfaces of the protruding portions, covered by the touch screen, give the appearance of a display area which is equal in area to the touch screen.

### BACKGROUND

1. Technical Field

The present disclosure relates to display screen assemblies for electronic devices.

2. Description of Related Art

Many electronic devices such as cellular phones, personal digital assistants (PDAs), and others, employ touch screens. Such electronic devices usually include a display screen, a touch screen for users to operate, and a housing for accommodating the display screen. The display screen has a display region and a non-display region surrounding the display region. It is desired to decrease the distance between the housing and a boundary of the display region for a greater display area. A typical method to do this is narrowing the non-display region. However, the effect of such a method is limited and the distance between the housing and the boundary of the display region still cannot meet aesthetic requirements.

Therefore, there is room for improvement within the art.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is an exploded view of a display screen assembly in accordance with an exemplary embodiment.

FIG. 2 is an enlarged and isometric view of the touch screen of FIG. 1

FIG. 3 is an isometric view of the display screen assembly of FIG. 1.

FIG. 4 is a cross sectional view of the electronic device taken along line IV-IV of FIG. 3.

FIG. 5 is an exploded partial view of the display screen assembly of FIG. 4.

### DETAILED DESCRIPTION

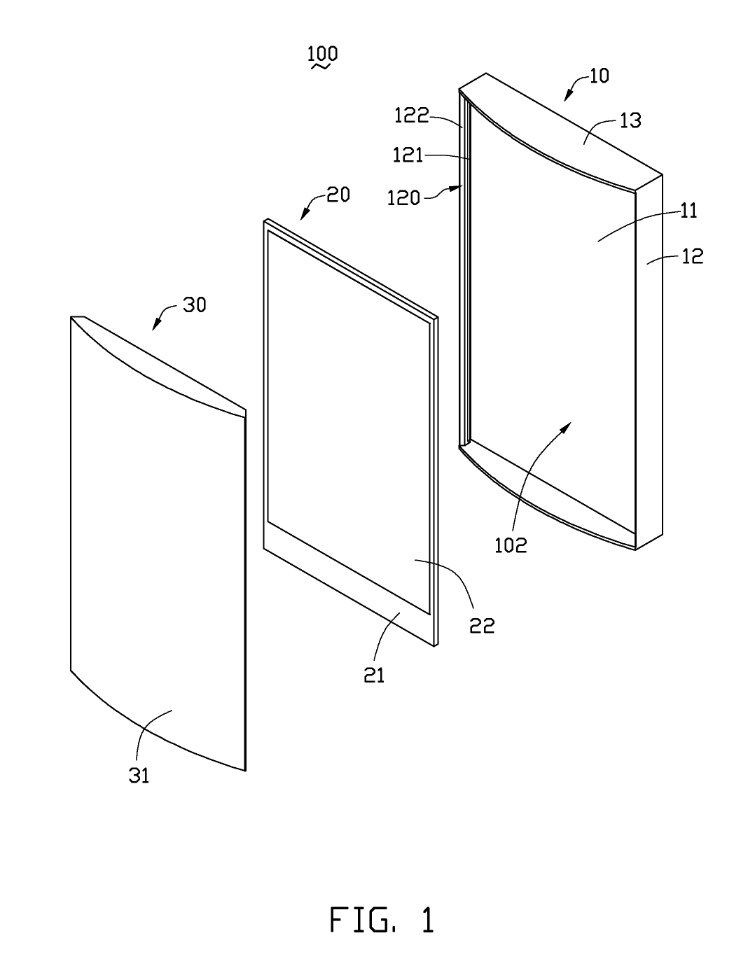

FIG. 1 shows an exemplary embodiment of a display screen assembly 100 including a shell 10, a display screen 20, and a touch screen 30. The shell 10 may be a housing of an electronic device, such as a mobile phone. The display screen 20 and the touch screen 30 are assembled to the shell 10.

The shell 10 includes a bottom board 11, two opposite side walls 12, and two opposite end walls 13. The two side walls 12 and the two end walls 13 perpendicularly extend from a periphery of the bottom board 11. The two side walls 12, the two end walls 13, and the bottom board 11 cooperatively surround an accommodating space 102. Each of the side walls 12 has a protruding portion 120 protruding from a top end 122 away from the bottom board 11 and extending in the accommodating space 102, thereby forming a latching groove 121 between each of the protruding portions 120 and the bottom board 11. Each protruding portion 120 extends longitudinally along the corresponding side wall 21 to form a strip shape and has a substantially triangular cross-section. Each protruding portion 120 has a supporting surface 122 supporting the touch screen 30. Each of the supporting surfaces 122 is a sloping surface tilted in towards the bottom board 11 at an angle of about 15 degrees to about 75 degrees. The latching grooves 121 are substantially rectangular and configured for latching the display screen 20 therein.

The display screen 20 includes a frame 21 and a display portion 22 surrounded by the frame 21. The display portion 22 displays information. The display screen 20 may be secured in the accommodating space 102 by two sides of the frame 21 being latched in the latching grooves 121.

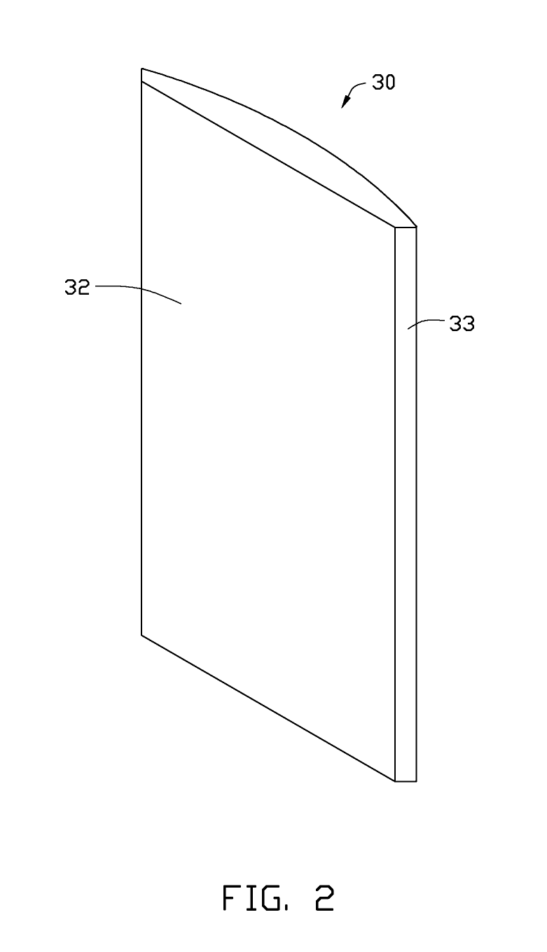

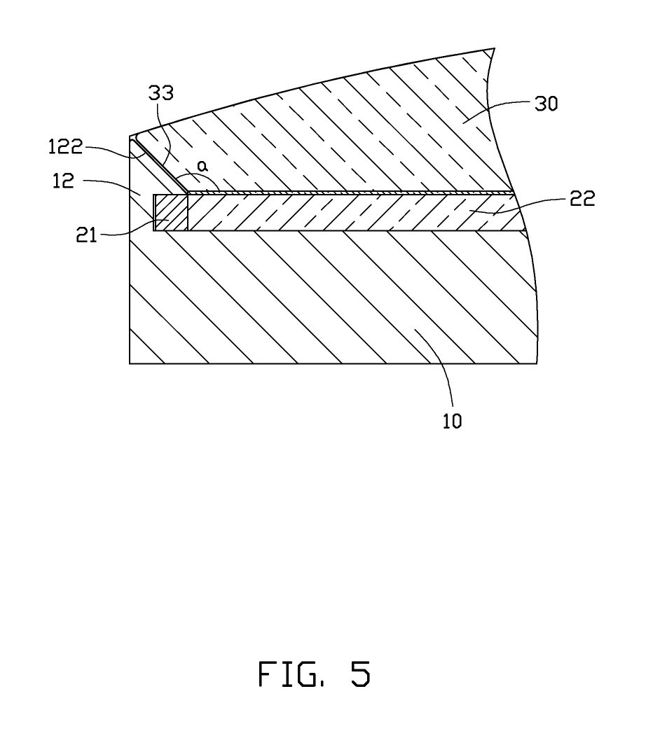

Referring to FIG. 2, the touch screen 30 may be a resistance touch screen or a capacitive touch screen. The touch screen 30 has a touching surface 31, an assembling surface 32 opposite to the touching surface 31, and two side surfaces 33 connecting the touching surface 31 and the assembling surface 32. The touching surface 31 is a convex arcuate surface. The area of the assembling surface 32 is substantially equal to the area of the display portion 22. The two side surfaces 33 are opposite to each other and slanted towards the assembling surface 32. The included angle α between each of the side surfaces 33 and the assembling surface 32 is about 105 degrees to about 165 degrees (see FIG. 5). The two side surfaces 33 are configured for engaging with the two supporting surfaces 122 of the shell 10.

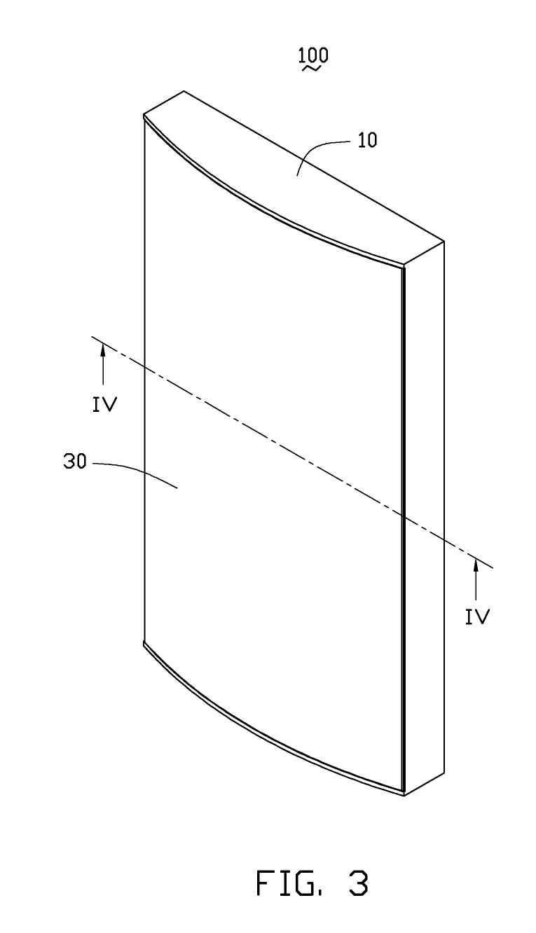

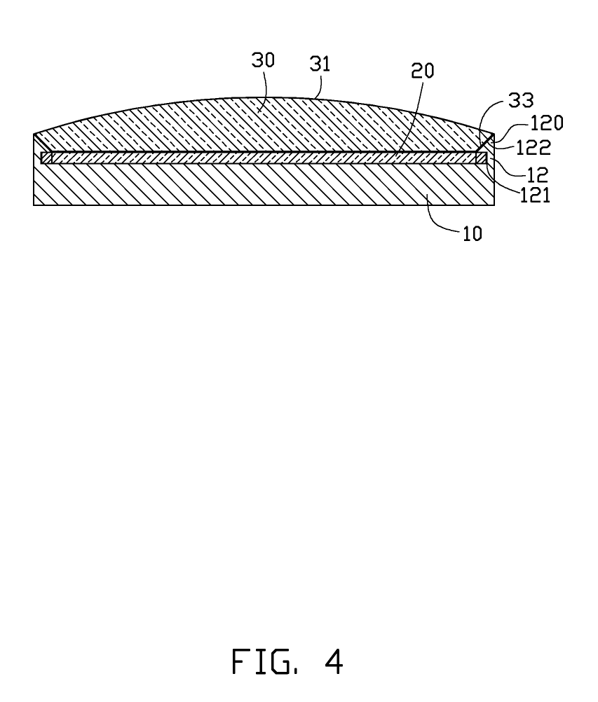

Referring to FIGS. 3-5, in assembly, the display screen 20 is secured in the accommodating space 102 with two sides of the frame 21 latched in the latching grooves 121. The touch screen 30 is received in the accommodating space 102 with the two side surfaces 33 abutting the two supporting surfaces 122. The display screen 20 is located between the bottom board 11 and the touch screen 30. The assembling surface 32 of the touch screen 30 is in contact with the display portion 22 of the display screen 20. The two side surfaces 33 and the two supporting surfaces 122 may be bonded by transparent adhesive, such as transparent adhesive tape.

Because the included angle α between each of the side surfaces 33 and the assembling surface 32 is about 105 degrees to about 165 degrees, and the supporting surfaces 122 engaged with the side surfaces 33 are sloping, when the display screen 20 is illuminated, the light emitted by the display screen 20 is reflected by the supporting surfaces 122 to the outer edges of the touch screen 30 as seen by users, and the supporting surfaces 122 itself have the appearance of the display screen 20, the supporting surfaces 122 become indistinguishable from the display screen 20. As such, the distance between edges of the shell 10 and the display portion 22 of the display screen 20 is greatly decreased.

The two supporting surfaces 122 can be coated with light reflecting material.

The two opposite end walls 13 also form sloping surfaces at top ends. The touch screen 30 thus has another two sloping side surfaces engaging with the sloping surfaces of the two opposite end walls 13.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A display screen assembly, comprising:
a shell comprising two opposite side walls and an accommodating space, each of the two side walls comprising a protruding portion protruding therefrom and extending toward the accommodating space, each of the two protruding portions having a supporting surface, each supporting surface having a sloping surface;
a display screen received in the accommodating space; and
a touch screen also received in the accommodating space, and comprising two opposite side surfaces, each side surface being a sloping surface that engages with one of the supporting surfaces.

2. The display screen assembly as claimed in claim 1, wherein each of the protruding portions extends longitudinally along the corresponding side wall to form a strip shape having a substantially triangular cross-section.

3. The display screen assembly as claimed in claim 1, the shell further comprising a bottom board and two opposite end walls; the two side walls and the two end walls perpendicularly extend from a periphery of the bottom board; the two side walls, the two end walls, and the bottom board cooperatively surround the accommodating space.

4. The display screen assembly as claimed in claim 3, wherein each of the two protruding portion protrudes form a top end of the corresponding side wall, thereby forming a latching groove between each of the protruding portions and the bottom board; the display screen comprising a frame and a display portion surrounded by the frame; the frame is latched in the latching grooves.

5. The display screen assembly as claimed in claim 4, wherein the touch screen further comprises a touching surface and an assembling surface in contact with the display screen; the included angle between each of the side surfaces and the assembling surface is about 105 degrees to about 165 degrees.

6. The display screen assembly as claimed in claim 5, wherein the assembling surface has an area substantially equal to the area of the display portion.

7. The display screen assembly as claimed in claim 5, wherein the touching surface is a convex arcuate surface.

8. The display screen assembly as claimed in claim 1, wherein the two support surfaces are coated with light reflecting material.

9. A display screen assembly, comprising:
a shell comprising two opposite side walls and an accommodating space, each of the two side walls having a supporting surface;
a display screen received in the accommodating space; and
a touch screen also received in the accommodating space and located upon the display screen, the touch screen comprising two opposite side surfaces and a touching surface, each side surface abutting against one of the supporting surfaces;
wherein the supporting surfaces reflect light emitted by the display screen to outer edges of the touch screen, causing the supporting surfaces to have the appearance of the display screen, the supporting surfaces become indistinguishable from the display screen.

10. The display screen assembly as claimed in claim 9, wherein each of the two side walls comprises a protruding portion protruding therefrom and extending toward the accommodating space; each of the two protruding portions has one of the two supporting surfaces; each of the two supporting surfaces is a sloping surface.

11. The display screen assembly as claimed in claim 9, wherein each side surface has a sloping surfaces engaging with one of the supporting surfaces.

12. The display screen assembly as claimed in claim 9, wherein each of the protruding portions extends longitudinally along the corresponding side wall to form a strip shape and has a substantially triangular cross-section.

13. The display screen assembly as claimed in claim 9, wherein the shell further comprising a bottom board and two opposite end walls; the two side walls and the two end walls perpendicularly extend from a periphery of the bottom board; the two side walls, the two end walls, and the bottom board cooperatively surround the accommodating space.

14. The display screen assembly as claimed in claim 13, wherein each of the two protruding portion protrudes form a top end of the corresponding side wall, thereby forming a latching groove between each of the protruding portions and the bottom board; the display screen comprising a frame and a display portion surrounded by the frame; the frame is latched in the latching grooves.

15. The display screen assembly as claimed in claim 14, wherein the touch screen further comprises a touching surface and an assembling surface in contact with the display screen; the included angle between each of the side surfaces and the assembling surface is about 105 degrees to about 165 degrees.

16. The display screen assembly as claimed in claim 15, wherein the assembling surface has an area substantially equal to the area of the display portion.

17. The display screen assembly as claimed in claim 15, wherein the touching surface is a convex arcuate surface.

18. The display screen assembly as claimed in claim 9, wherein the two support surfaces are coated with light reflective material.
